(19) United States
(12) Patent Application Publication
(10) Pub. No.: US 2025/0125566 A1
(43) Pub. Date: Apr. 17, 2025

(54) HOUSING FOR A SHIELDED ELECTRICAL CONDUCTOR AS WELL AS CONDUCTOR ARRANGEMENT AND CONNECTOR

(71) Applicant: TE Connectivity Solutions GmbH, Schaffhausen (CH)

(72) Inventors: Wolfgang BALLES, Bensheim (DE); Walter SAENGER, Bensheim (DE); Heiko WOLFSCHMITT, Bensheim (DE); Thomas HULBERT, Bensheim (DE)

(21) Appl. No.: 18/912,718

(22) Filed: Oct. 11, 2024

(30) Foreign Application Priority Data
Oct. 11, 2023 (DE) 102023127817.7

(51) Int. Cl. H01R 13/6597; H01R 13/502

(52) U.S. Cl. CPC H01R 13/6597; H01R 13/502

(57) ABSTRACT

A housing for a shielded electrical conductor includes a first receptacle for the shielded electrical conductor having an open end receiving the shielded electrical conductor and a second receptacle having an opening receiving an earthing conductor. The housing includes a transition region which extends in the longitudinal direction of the first receptacle adapted to receive an electrical contact element for connecting the shielding of the shielded electrical conductor to the earthing conductor. The second receptacle is separated from the first receptacle by at least one wall extending in the longitudinal direction of the first receptacle.

### CROSS REFERENCE TO RELATED APPLICATIONS

This application claims the benefit of DE Application No. 102023127817.7, filed 11 Oct. 2023, the subject matter of which is herein incorporated by reference in its entirety.

### BACKGROUND OF THE INVENTION

The subject matter herein relates to a housing for a shielded electrical conductor and a conductor arrangement for insertion into such a housing.

Electrical connectors are used to connect electrical conductors, such as busbars, to each other in an electrically conductive manner. Connectors usually provide at least one electrical conductor that can be inserted into and received in a housing. The electrical conductor often has electromagnetic shielding. During operation—especially with high currents or voltages—currents or signals can occur in the shielding, which should be dissipated.

The provision of such a derivation is often accompanied by a complex structure and a time-consuming assembly process for the connector, especially in the absence of automation.

There is a need for an electrical connector having simple construction for dissipation of high currents and voltages.

### BRIEF DESCRIPTION OF THE INVENTION

In one embodiment, a housing is provided for a shielded electrical conductor, for example a busbar, with a first receptacle for the shielded electrical conductor, in the longitudinal direction of which the shielded electrical conductor can be inserted from an open end of the first receptacle, and with a second receptacle for an earthing conductor, into which the earthing conductor can be introduced through an opening and which has a transition region which extends in the longitudinal direction of the first receptacle, the transition region being adapted to receive an electrical contact element for connecting the shielding of the shielded electrical conductor to the earthing conductor, wherein the second receptacle is separated from the first receptacle by at least one wall extending in the longitudinal direction of the first receptacle.

By providing two separate receptacles, one shielded electrical conductor and one earthing conductor can be received separately from each other in the housing. On the one hand, this has the advantage of improved guidance of the conductors within their respective receptacles. On the other hand, it simplifies assembly and ensures a secure, low-backlash fit of the conductors in the housing. This ensures particularly reliable electrical connections and prevents damage to the conductors.

In various embodiments, the housing can be further improved by the following features, each of which is preferred and can be combined with one another as desired.

The housing can be part of the conductor arrangement mentioned introductorily. The earthing conductor can also be adapted as an earth and connected to a vehicle body, for example. The earthing conductor can also serve or be adapted as a signal conductor via which electrical signals, in particular in the range of low voltages or currents, can be transmitted. Moreover, the earthing conductor can have a connector adapted for contacting the contact element, for example a crimp connector or a pigtail. Possible examples of connectors that can be used are MCP 6.3 and SCON6 connectors. Of course, other standardized or non-standardized connectors are also conceivable.

The shielded electrical conductor may have an insulator arranged at least partially between the shielded electrical conductor and the shielding. The electrical conductor can also be essentially cylindrical, tubular or cuboid in shape. Analogously, the shielding and/or the insulator and/or one of the receptacles can also be essentially cylindrical, tubular or cuboid in shape. In particular, the electrical conductor, the insulator and the shielding can be arranged coaxially to one another.

According to one configuration, an enclosure surrounding the first receptacle or a housing section surrounding the first receptacle can be sealed relative to the electrical conductor. The electrical conductor or the shielding can be surrounded in an area by a seal that seals a gap between the electrical conductor or the shielding of the electrical conductor and the enclosure surrounding the first receptacle or the housing section surrounding the first receptacle.

The contact element can be Z-shaped and in particular have two sections arranged parallel to each other, which can extend at an angle, preferably at a right angle, to another section of the contact element. The contact element can also be flat and have a rectangular cross-section, for example. In one configuration, the contact element can be at least partially curved and thus have the shape of a hollow cylinder shell segment, for example. It is also possible for the contact element to have a configuration that complements the wall of the housing or the enclosure of the housing.

According to a preferred embodiment, the contact element can be inserted into the housing. In addition, an embedding of the contact element in the housing can be provided. This configuration allows the contact element to be fixed relative to the housing, which simplifies the assembly of the shielded electrical conductor with the housing. In particular, the contact element can be secured captively.

In one configuration, the contact element can be part of the housing.

In order to make the contact element more easily accessible for making contact with the earthing conductor and/or the shielding, the contact element can protrude from the housing into the first and second receptacles according to a further aspect.

The contact element can, for example, protrude from an enclosure of the housing, in particular in the transition region. The part of the housing from which the contact element protrudes into the first and second receptacles can be the part of the housing into which the contact element is inserted. The contact element may extend at least partially perpendicular to the wall of the housing, an enclosure of the first receptacle, or the longitudinal direction of the first receptacle, or the longitudinal direction of the second receptacle. In particular, a section of the contact element can extend along the longitudinal direction of the first receptacle and/or a further section of the contact element can extend along the longitudinal direction of the second receptacle.

In one aspect, the contact element can have a plug contact adapted for contacting the earthing conductor at an end projecting into the second receptacle. This configuration makes it possible to establish contact between the contact element and the earthing conductor easily and reliably. This reduces the assembly effort and increases the quality of the electrical connection.

The end of the contact element protruding into the second receptacle can be configured as a plug contact. In particular, a standardized plug contact can be used. The plug contact can, for example, be configured as a contact lug, crimp cable lug, tubular cable lug or compression cable lug. Furthermore, the plug contact can be flat and thus be adapted as a flat conductor, for example.

In order to further improve the quality of the electrical connection between the contact element and the shielding, the contact element can be configured as a contact spring at one end protruding into the first receptacle according to another preferred embodiment. The contact spring can be a crown spring, for example.

The contact spring can be elastically deflectable, in particular radially outwards, and adapted to exert a contact force on the shielded electrical conductor. The contact force can act radially in-wards or in the direction of a center of the first receptacle and can, for example, be a normal contact force. The contact spring can be elastically deflected and/or deflected radially outwards or in the direction away from the center of the first receptacle by the shielded electrical conductor held in the first receptacle. The contact force can be caused by a restoring force of the contact spring that counteracts the deflection.

In one configuration, the contact spring can extend at least partially in the circumferential direction of the first receptacle. Furthermore, the contact spring can be at least partially complementary to the electrical conductor and/or the shielding of the electrical conductor and/or the wall of the housing and/or an enclosure of the first receptacle.

According to another preferred embodiment, the second receptacle can be closed in the transition region for the earthing conductor. In particular, it is possible that the earthing conductor does not protrude into the first receptacle. Furthermore, the housing can be adapted such that there is no passage—or at least no passage open for the earthing conductor—between the first and second receptacles. In one embodiment, the second receptacle can only be open for the contact element in the transition region. In addition, the transition region for the earthing conductor can be closed by that part of the housing or wall in which the contact element is inserted and/or in which the contact element is embedded.

According to a further aspect, the longitudinal direction of the second receptacle can extend parallel or at a right, obtuse or acute angle to the longitudinal direction of the first receptacle. Due to these configurations, the geometry of the housing can be flexibly adapted to the spatial requirements or restrictions of various installation situations, in particular to certain conductor outlet directions. According to one embodiment, the first and second receptacles can be arranged parallel to each other in terms of radius.

In a preferred embodiment, the contact element can be at least partially overmolded by the housing. This allows the contact element to be firmly fixed in the housing, which simplifies the contacting of the contact element with the earthing conductor and/or the shielding and improves the quality of the electrical connection. Furthermore, the manufacturing costs of the housing can be reduced as a result of an easily automated injection molding process.

The housing can be injection-molded, in particular completely injection-molded. Furthermore, the contact element can be completely overmolded by the housing. The overmolding of the contact element can be realized by the insert molding process. In one configuration, the housing part forming the overmolding can be arranged in the transition region. Furthermore, the wall of the housing may represent and/or comprise the housing part forming the overmolding.

According to a further preferred embodiment, the first receptacle can have a bulge extending along its longitudinal direction, along which the contact element can be inserted. Such housing enables an electrical contact element to be received which extends further outwards than the first receptacle in relation to the radial direction. Furthermore, the bulge helps to protect and/or guide the contact element.

In one configuration, only a part of the contact element can be inserted along the bulge. The contact element and/or a part of the contact element can protrude outwards or away from the center of the first receptacle, in particular along the radial direction.

The bulge can be adapted to complement the contact element or a part of the contact element that can be inserted along the bulge. The bulge can be configured as a slot or have the shape of a hollow cylinder segment. According to one configuration, the bulge is only slightly wider in the circumferential direction of the first receptacle than the contact element or than the part of the contact element that can be inserted along the bulge. In particular, the bulge can be configured in such a way that the contact element or the part of the contact element is not or only slightly movable in the circumferential direction of the first receptacle.

According to a further preferred embodiment, the housing can have a third receptacle for a further electrical conductor, which is connected to the first receptacle at a second end arranged opposite the open end in the longitudinal direction of the first receptacle. This configuration increases the range of application of the housing. In particular, such a housing can be used to receive a shielded electrical conductor which is to be connected to an electrical infrastructure or an electrical device via the further electrical conductor.

The longitudinal directions of the first and third receptacles can have an angle of 90° to each other. In addition, the longitudinal directions of the first, second and third receptacles can lie in a common plane. According to a further configuration, the longitudinal direction of one receptacle can extend at right angles to the longitudinal directions of the other two receptacles.

The shielded electrical conductor and the further electrical conductor can be electrically conductively connected and/or connectable to each other in the housing, for example at the transition between the first and third receptacle or in the first or third receptacle. The shielded electrical conductor can lead into a flange section, via which the electrical conductor can be fastened to a further housing using a fastening means. Examples of such fastening means are bolts or screws. Furthermore, the fastening means can be at least partially received in the third receptacle.

The further electrical conductor can be configured as a socket or as the fastening means. The third receptacle can have an enclosure, via the end of which the housing can be plugged together or connected to the further housing. The further housing can be part of a battery system, for example.

The problem mentioned introductorily is further solved by a conductor arrangement for insertion into a housing, wherein the shielded electrical conductor has a shielding which provides a contact point arranged at the level of the transition region with respect to the longitudinal direction of the first receptacle, via which the shielding can be connected to the contact element. The provision of such a contact point is preferred in terms of a reliable and high-quality electrical connection between the shielding and the contact element.

The contact point can lie on the bare shielding or be the bare shielding and extend in particular along the circumferential direction of the first receptacle. Preferably, the contact point extends completely, but at least partially, along the shielding of the electrical contact element. The contact point can also be cylindrical, cylindrical shell-shaped or cylindrical shell-segment-shaped.

In a preferred configuration, the conductor arrangement can have an electrically conductive socket that rests on the shielding at the contact point. The provision of a socket is a cost-effective and, in terms of assembly, simple way of enabling the shielding of the electrical conductor to make contact with the contact element.

The electrically conductive socket can, for example, be a crimp socket, a crimping sleeve, a crimping ferrule, a simple sleeve or a shielding sleeve.

The socket can be attached to the shielding, plugged on, placed on, clamped on and/or fastened. The socket can be attached to the shielding by plastic deformation, for example by crimping. The socket can project radially outwards from the shielding or away from the center of the first receptacle.

Preferably, the socket can be attached without orientation at the contact point or on the shielding. The fact that it can be attached without orientation can mean that the relative alignment of the socket in relation to the circumferential direction of the shielding or the electrical conductor is irrelevant during assembly.

According to another preferred embodiment, the socket can be provided with the contact element. In this way, the number of individual parts of the conductor arrangement is reduced, which helps to reduce production costs and simplify assembly.

Preferably, the socket is mechanically and electrically connected to the contact element. The contact element may further be attached to the socket by a fastening means and/or be monolithically formed with the socket. The contact element can extend outwards from the socket or from a part of the socket not comprising the contact element or away from the center of the first receptacle, for example radially. The socket can be configured such that the contact element of the socket only comes into contact with the earthing conductor when it is fully assembled.

The above problem is further solved by an electrical connector with a housing according to the invention and a conductor arrangement according to the invention inserted into the housing. The conductor arrangement can also be inserted into, plugged into or received in the housing. The electrical connector can be assembled easily and automatically and meets a wide variety of requirements, in particular with regard to the installation space available for the installation and different conductor outlet directions.

According to a preferred configuration, the electrical connector can have an earthing conductor that is connected to the contact element in the transition region. The earthing conductor can also be connected to the shielding of the electrical conductor. An electrical connector according to this configuration is able to reliably discharge electrical currents occurring in the shielding.

In the following, the invention is explained in more detail by means of embodiments with reference to the attached Figures. In this context, individual features present in the embodiment below can be omitted if the technical effect associated with this feature is not important according to the above embodiments. Conversely, a feature described above but not present in an embodiment below can be added to the embodiment if the technical effect associated with this feature is important for a particular application.

### BRIEF DESCRIPTION OF THE DRAWINGS

In the following, the same reference signs are used for elements that correspond to each other in terms of structure and/or function. It is shown by:

FIG. 1 a schematic perspective view of a housing with a shielded electrical conductor and an earthing conductor according to a possible embodiment;

FIG. 2 a schematic perspective view of a housing according to a possible embodiment;

FIG. 3 a schematic perspective view of a housing according to a further possible embodiment;

FIG. 4 a schematic perspective view of an electrical connector according to a possible embodiment;

FIG. 5 a schematic perspective view of a housing with a shielded electrical conductor and an earthing conductor according to a further possible embodiment.

### DETAILED DESCRIPTION OF THE INVENTION

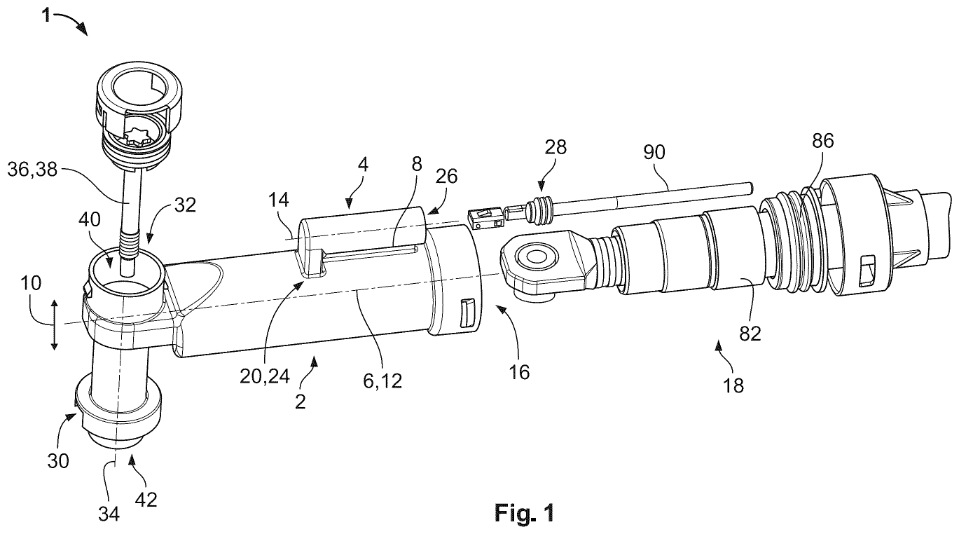

In the following, the structure of a housing is described by way of example with reference to FIG. 1 to FIG. 4.

The housing 1 has a first receptacle 2 and a second receptacle 4. The second receptacle 4 is separated from the first receptacle 2 by at least one wall 8 extending along a longitudinal direction 6 of the first receptacle 2. In the embodiment shown in FIG. 1, the wall 8 is formed by a beam-shaped housing section 12 extending along the longitudinal axis 6 of the first receptacle 2 and along a radial direction 10 of the first receptacle 2.

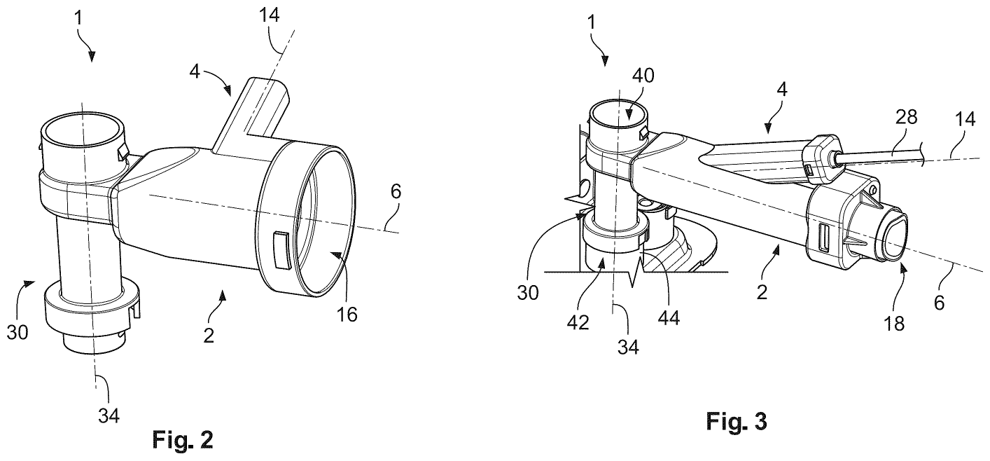

In the configuration shown in FIG. 1, the first receptacle 2 and the second receptacle 4 are essentially cylindrical and their longitudinal directions 6, 14 run parallel to each other. According to the embodiments shown in FIG. 2 and FIG. 3, however, the longitudinal direction 14 of the second receptacle 4 can also extend at a right angle to the longitudinal direction 6 of the first receptacle 2, as shown in FIG. 2, or at an acute angle, as can be seen in FIG. 3. According to a further embodiment, the angle between the longitudinal direction 6 of the first receptacle 4 and the longitudinal direction 14 of the second receptacle 4 can also be obtuse. Furthermore, at least one of the receptacles 2, 4 may have a shape other than cylindrical, for example a substantially cuboid shape.

The first receptacle 2 has an open end 16, through which the first receptacle 2 is accessible from outside the housing 1. For example, a shielded electrical conductor 18 can be inserted into the first receptacle 2 via the open end 16 along the longitudinal direction 6 of the first receptacle 2 and at least partially received therein.

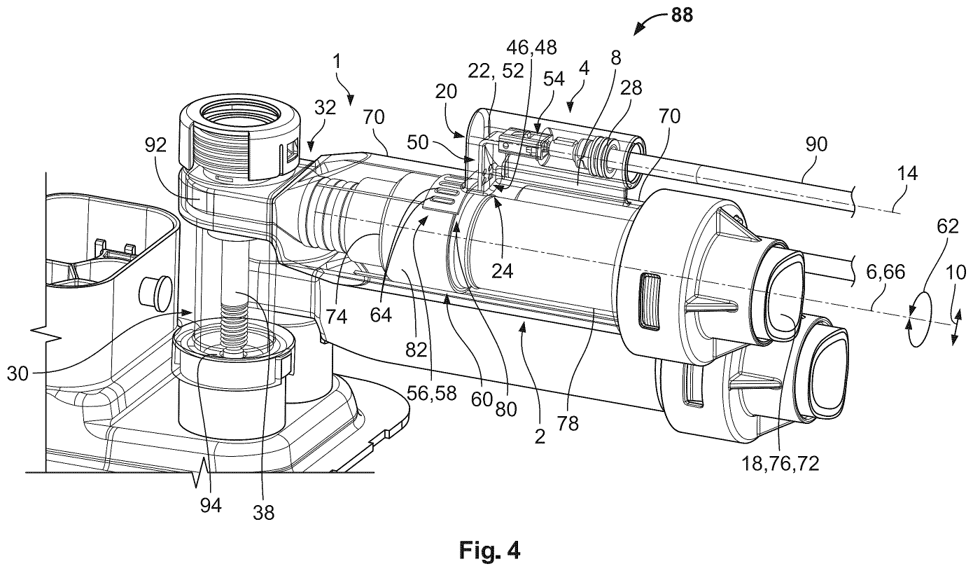

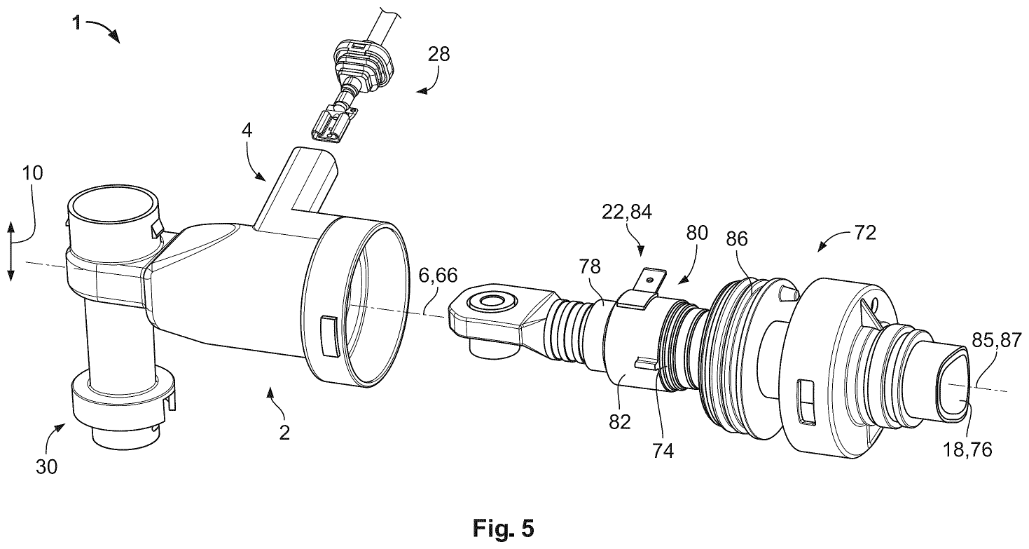

The housing 1 further comprises a transition region 20, which is adapted to receive an electrical contact element 22 (shown in FIG. 4). The transition region 20 extends along the longitudinal direction 6 of the first receptacle 2 and may, as shown in FIGS. 1 and 4 by way of example, have a passage 24 between the first receptacle 2 and the second receptacle 4 or be formed by the latter. In particular, the second receptacle 4 can lead into the first receptacle 2.

The second receptacle 4 has an opening 26 through which the second receptacle 4 is accessible from outside the second receptacle 4 or from outside the housing 1. The second receptacle 4 is adapted to receive an earthing conductor 28, which can be inserted into the second receptacle 4 through the opening 26 along the longitudinal direction 14 of the second receptacle 4.

According to one possible configuration, the second receptacle 4 can be closed in the transition region 20 for the earthing conductor 28. Thus, the earthing conductor 28 can be received in the second receptacle 4, however it cannot protrude in the transition region 20 or over the transition region 20 or through the transition region 20 into the first receptacle 2.

The housing 1 may further comprise a third receptacle 30, which is connected to the first receptacle 2 at a second end 32 of the first receptacle 2. The second end 32 of the first receptacle 2 is opposite the open end 16 of the first receptacle 2 with respect to the longitudinal direction 6 of the first receptacle 2. In the embodiments shown in FIGS. 1-3, the third receptacle 30 has a substantially cylindrical shape and a longitudinal direction 34 of the third receptacle 30 extends at right angles to the longitudinal direction 6 of the first receptacle 2 and at right angles to the longitudinal direction 14 of the second receptacle 4. In particular, the longitudinal directions 6, 14, 34 of the first, second and third receptacles 2, 4, 30 lie in a common plane in the embodiment shown in FIG. 1.

The third receptacle 30 can be adapted to receive a further electrical conductor 36. As can be seen from FIG. 1, the further electrical conductor 36 can be configured as an electrically conductive fastening element 38, which can make electrically conductive contact with a shielded electrical conductor 18 received in the first receptacle 2.

In addition, the further electrical conductor 36 or the electrically conductive fastening element 38 can be inserted into the third receptacle 30 via an upper opening 40 of the third receptacle 30. Furthermore, the third receptacle 30 can have a lower opening 42, which can lie opposite the upper opening 40 in relation to the longitudinal direction 34 of the third receptacle 30. At the lower opening 42, as can be seen from FIG. 3, the housing 1 can be connectable or pluggable together with a further housing 44. The further housing 44 can, for example, be part of a battery or a battery system, in particular of a vehicle.

Furthermore, the electrical contact element 22 can be inserted into the housing 1. In the embodiment according to FIG. 4, the electrical contact element 22 is partially overmolded by the housing, wherein an overmolded area 46 of the electrical contact element 22 is located in the transition region 20. In this embodiment, the second receptacle 4 is separated from the first receptacle 2 by the electrical contact element 22 and a part 48 of the housing 1 forming the overmolding of the electrical contact element 22. The part 48 of the housing 1 forming the overmolding can be part of the wall or a wall 8.

According to a further configuration, it is possible that there is a gap 50 between the electrical contact element 22 inserted into the housing 1 and the housing 1, in particular in the transition region 20. The gap 50 can extend along the longitudinal direction 6 of the first receptacle 2 and perpendicular to the longitudinal direction 6 of the first receptacle 2. As a result, the electrical contact element 22 can be movable or displaceable in the transition region 20 in particular.

In the embodiment shown in FIG. 4, the electrical contact element 22 received in the transition region 20 protrudes from the housing 1 into the first and second receptacles 2, 4. At its end 52 protruding into the second receptacle 2, the electrical contact element 22 according to this configuration has a plug contact 54, which is adapted to make contact with the earthing conductor 28 receivable in the second receptacle 4. As can be further seen from FIG. 4, the plug contact 54 of the electrical contact element 22, which is configured as a flat contact, extends along the longitudinal direction 14 of the second receptacle 4.

Furthermore, the electrical contact element 22 can be configured as a contact spring 58 at its end 56 projecting into the first receptacle 2. In the embodiment shown, the end 56 or the contact spring 58 projecting into the first receptacle 2 extends essentially along the longitudinal direction 6 of the first receptacle 4. In FIG. 4, the contact spring 58 has, by way of example, approximately the shape of a cylindrical shell segment, which is adapted to complement an outer contour 60 of the shielded electrical conductor 18 that can be received in the first receptacle 2.

In the embodiment shown in FIG. 4, the contact spring 58 further comprises contact curvatures 64 arranged parallel to each other along the longitudinal direction 6 of the first receptacle 2 and along a circumferential direction 62 of the first receptacle 2, which project in the direction of a center 66 of the first receptacle 2. The contact curvatures 64 may be configured to contact a shielded electrical conductor 18 received in the first receptacle 2.

The contact spring 58 may further be configured to be elastically deflected perpendicularly to the longitudinal direction 6 of the first receptacle 2 or outwards in the radial direction 10, that is, away from the center 66 of the first receptacle 2. In this way, the contact spring 58 can effect a restoring force in the opposite direction to the deflection, which can be effected inwards in the radial direction 10 or in the direction of the center 66 of the first receptacle 2 on a shielded electrical conductor 18 received in the first receptacle 2.

According to one configuration, the first receptacle 2 can have a bulge 68 (not visible) along which the electrical contact element 22 or at least a part of the electrical contact element 22 can be inserted into the first receptacle 2. The bulge 68 extends along the longitudinal direction 6 of the first receptacle 2 and may be recessed into a wall 70 of the first receptacle 2.

In the following, the structure of a conductor arrangement 72 is explained by way of example with reference to FIG. 4 and FIG. 5.

The conductor arrangement 72 comprises the electrical conductor 18 and a shielding 74. In the example shown, the electrical conductor 18 is configured as a substantially cylindrical busbar 76, which is partially coaxially surrounded by the substantially cylindrical shielding 74. An insulator 78 may be arranged between the shielding 74 and the shielded electrical conductor 18, by means of which the electrical conductor 18 and the shielding 74 are electrically decoupled.

The shielding 74 provides a contact point 80 via which the shielding 74 can be connected to the electrical contact element 22. When the conductor arrangement 72 is fully inserted into the housing 1, in particular into the first receptacle 2 of the housing 1, the contact point 80 is at the level of the transition region 20 with respect to the longitudinal direction 6 of the first receptacle 2.

In the embodiment shown in FIG. 4, the conductor arrangement 72 has an electrically conductive socket 82 which rests on the shielding 74 at the contact point 80. In the case shown, the socket 82 completely encloses the shielding 74 of the electrical conductor 18 along the circumferential direction 62.

As can be seen in the embodiment of the conductor arrangement 72 according to FIG. 5, the socket 82 can be provided with the electrical contact element 22. In the present case, the electrical contact element 22 is configured as a contact fin 84 extending away from the center 66 of the first receptacle 2 of the housing 1 or outwards in the radial direction 10. For inserting the conductor arrangement 72 into the first receptacle 2 of the housing 1, the housing 1 can have the bulge 68 already described.

As can also be seen from FIG. 5, the conductor arrangement 72 can also have a seal 86, which can be adapted to seal the conductor arrangement 72 inserted into the first receptacle 2 of the housing 1 relative to the housing 1. In the embodiment shown, the seal 86 is configured as a radial seal which extends coaxially or concentrically around a longitudinal direction 85 of the electrical conductor 18 or a longitudinal direction 87 of the shielding 74.

The structure of an electrical connector 88 is explained below with reference to FIG. 4.

The electrical connector 88 has the housing 1 according to the invention and a conductor arrangement 72 inserted into the first receptacle 2 of the housing 1.

FIG. 4 shows an example of a housing 1 with three receptacles 2, 4, 30, the longitudinal directions 6, 14, 34 of which lie in a common plane. Furthermore, the longitudinal directions 6, 14 of the first and second receptacles 2, 4 extend parallel to each other. The housing 1 has the electrical contact element 22, which is overmolded by the housing 1 and protrudes from the housing 1 into the first 2 and second receptacle 4 in the transition region 20 of the housing 1.

The end 56 of the electrical contact element 22 protruding into the first receptacle 2 extends along the longitudinal direction 6 and the circumferential direction 62 of the first receptacle 2. The end 52 of the electrical contact element 22 protruding into the second receptacle 2 is configured as a flat plug contact 54, which extends along the longitudinal direction 6 of the second receptacle 2. The plug contact 54 is connected or plugged together in the second receptacle 2 with the earthing conductor 28, which is received in the second receptacle 2 along the longitudinal direction 14 thereof. An electrical cable 90, which can be a component of the exemplary earthing conductor 28, can be connected to an earth potential, for example to the body of a vehicle.

The conductor arrangement 72 of the illustrated embodiment has the shielded electrical conductor 18 and an electrically conductive socket 82 arranged at the contact point 80 and resting on the shielding 74. The socket 82 shown extends completely around the shielding 74 of the electrical conductor 18 with respect to the circumferential direction 62 of the first receptacle 2. The conductor arrangement 72 is inserted into the housing 1 so that one end of the electrical conductor 18, which is configured as a flange section 92, protrudes through the second end 32 of the first receptacle 2 into the third receptacle 30. In the third receptacle 30, the electrical conductor 18 is connected via the flange section 92 to the electrically conductive fastening element 38 received in the third receptacle 30. In the embodiment shown, the fastening element 38 is connected to a mating contact 94 arranged in the further housing 44.

In the embodiment shown in FIG. 4, the shielding 74 is electrically conductively connected to the electrical contact element 22 via the socket 82 resting on the contact point 80. In particular, the end 56 of the electrical contact element 22, which is configured as a contact spring 58 and projects into the first receptacle 2, is in contact with the socket 82. The contact spring 58 shown is configured in the shape of a cylindrical shell segment and is thus complementary to the cylindrical outside of the socket 82.

During operation of the electrical connector 88, currents may flow through the shielded electrical conductor 18 as a result of which electrical currents and/or signals may occur in the shielding 74 of the electrical conductor 18. These currents and/or signals can be discharged from the shielding 74 via the earthing conductor 28 connected to the shielding 74 of the electrical conductor 18. For this purpose, the currents first flow via or at the contact point 80 from the shielding 74 into the socket 82 and are then transmitted into the electrical contact element 22 via the contact spring 58 in contact with the socket 82. Subsequently, the currents are introduced into the earthing conductor 28 connected thereto via the end 52 of the contact element 22, which protrudes into the second receptacle 4 and is exemplarily configured as a plug contact 54 in FIG. 3.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Housing for a shielded electrical conductor comprising:
a first receptacle having an open end, the first receptacle configured to receive the shielded electrical conductor in a longitudinal direction through the open end of the first receptacle; and
a second receptacle having an opening, the second receptacle configured to receive an earthing conductor through the opening, the second receptacle including a transition region extending in the longitudinal direction of the first receptacle, the transition region configured to receive an electrical contact element for connecting the shielding of the shielded electrical conductor to the earthing conductor;
the second receptacle being separated from the first receptacle by at least one wall extending in the longitudinal direction of the first receptacle.

2. Housing according to claim 1, wherein the contact element is inserted into the housing.

3. Housing according to claim 1, wherein the contact element protrudes from the housing into the first and second receptacle.

4. Housing according to claim 3, wherein the contact element includes a plug contact at an end protruding into the second receptacle, the plug contact configured to make contact with the earthing conductor.

5. Housing according to claim 3, wherein the contact element includes a contact spring at an end protruding into the first receptacle.

6. Housing according to claim 1, wherein the second receptacle is closed in the transition region for the earthing conductor.

7. Housing according to claim 1, wherein the longitudinal direction of the second receptacle extends parallel to the longitudinal direction of the first receptacle.

8. Housing according to claim 1, wherein the longitudinal direction of the second receptacle extends at a right, obtuse or acute angle to the longitudinal direction of the first receptacle.

9. Housing according to claim 1, wherein the contact element is at least partially overmolded by the housing.

10. Housing according to claim 1, wherein the first receptacle has a bulge extending along the longitudinal direction along which the contact element is inserted.

11. Housing according to claim 1, further comprising a third receptacle for a further electrical conductor, the third receptacle being connected to the first receptacle at a second end arranged opposite the open end in the longitudinal direction of the first receptacle.

12. Electrical connector comprising:
a housing including a first receptacle and a second receptacle, the first receptacle having an open end, the first receptacle extending in a longitudinal direction, the second receptacle having an opening, the second receptacle including a transition region extending in the longitudinal direction of the first receptacle, the second receptacle being separated from the first receptacle by at least one wall extending in the longitudinal direction of the first receptacle; and
a conductor arrangement inserted into the housing, the conductor arrangement including a shielded electrical conductor, an earthing conductor, and an electrical contact element for connecting shielding of the shielded electrical conductor to the earthing conductor, the shielded electrical conductor received in the first receptacle in the longitudinal direction through the open end of the first receptacle, the earthing conductor received in the second receptacle through the opening, the electrical contact element received in the transition region.

13. Electrical connector according to claim 12, wherein the shielded electrical conductor has a shielding which provides a contact point arranged at the level of the transition region with respect to the longitudinal direction of the first receptacle, wherein the shielding is connected to the contact element via the contact point.

14. Electrical connector according to claim 12, wherein the conductor arrangement has an electrically conductive socket resting on the shielding at the contact point.

15. Electrical connector according to claim 14, wherein the socket is provided with the contact element.

16. Electrical connector according to claim 14, wherein the earthing conductor is connected to the contact element in the transition region.

17. Electrical connector according to claim 12, wherein the contact element protrudes from the housing into the first and second receptacle.

18. Electrical connector according to claim 12, wherein the contact element includes a plug contact at an end protruding into the second receptacle, the plug contact configured to make contact with the earthing conductor.

19. Electrical connector according to claim 12, wherein the second receptacle is closed in the transition region for the earthing conductor.

20. Electrical connector according to claim 12, wherein the housing includes a third receptacle for a further electrical conductor, the third receptacle being connected to the first receptacle at a second end arranged opposite the open end in the longitudinal direction of the first receptacle.
